(19) United States
(12) Patent Application Publication
(10) Pub. No.: US 2013/0074191 A1
(43) Pub. Date: Mar. 21, 2013

(54) METHOD FOR CONTROLLING CONTENT UPLOADED TO A PUBLIC CONTENT SITE

(71) Applicant: Ehud Ben-Reuven, New York, NY (US)

(72) Inventor: Ehud Ben-Reuven, New York, NY (US)

(21) Appl. No.: 13/623,485

(22) Filed: Sep. 20, 2012

Related U.S. Application Data
(60) Provisional application No. 61/536,603, filed on Sep. 20, 2011.
(60) Provisional application No. 61/538,167, filed on Sep. 23, 2011.
(60) Provisional application No. 61/539,938, filed on Sep. 27, 2011.
(60) Provisional application No. 61/550,144, filed on Oct. 21, 2011.
(60) Provisional application No. 61/553,882, filed on Oct. 31, 2011.

(51) Int. Cl. G06F 21/00; G06F 15/16

(52) U.S. Cl. 726/26

(57) ABSTRACT

A method allowing members of an organization to share content on a public content site without violating the organization's security policy. Instead of sharing an original content at a public content site in violation of the security policy, the originator shares a shared content which is included in a document provided at the public content site. The receiver's client transforms the document received from the public content site and replaces the shared content with a representation of the original content.

### RELATED APPLICATIONS

This application claims all rights of priority to U.S. Provisional Patent Application No. 61/536,603, filed on Sep. 20, 2011 (pending), U.S. Provisional Patent Application No. 61/538,167, filed on Sep. 23, 2011 (pending), U.S. Provisional Patent Application No. 61/539,938, filed on Sep. 27, 2011 (pending), U.S. Provisional Patent Application No. 61/550,144, filed on Oct. 21, 2011 (pending), and U.S. Provisional Patent Application No. 61/553,882, filed on Oct. 31, 2011 (pending), which are fully incorporated herein by reference.

### BACKGROUND

1. Field of the Invention

The invention generally relates to methods in which users in an organization share content such as videos, pictures, sound recording, and/or text using a public content site.

2. Related Arts

In a typical situation, an originating user generates or acquires a particular content and desires to allow a receiving user to experience a reproduction representing this content. For purposes of the present disclosure, the content at the start of this process is referred to as the original content. The original content can be of different types. For example, it may include video, photo, sound recording and/or text. The type of the original content can also be information recognized by computer software such as a part of an HTML document, or a part of a computer code. Also, for purposes of the present disclosure, the originator is a member of an organization in which a security policy is desired. The security policy specifies who is authorized to receive the content, who is not authorized, and what are the conditions of such authorization. The conditions can be based on the identity of the receiver, on his group membership or roll, on the location of the receiver, or the time of the receipt of the content. Optionally, a security policy results in supplying different representations of the original content to different receivers. For example, a security policy may specify that a picture may only be shared with other members of the organization, and members of different departments can have access to a different resolution of the same picture. Optionally, a security policy may also specify that conditions under which the content is received or viewed by the receiver should be audited and stored in a secure auditing repository.

The term “secure” is used herein to describe any part of a system that can be trusted to implement the security policy.

An “organization” can be any grouping of people capable of enforcing the policy on its members, for example, a corporation, a group of companies working together or even social structures, such as families or group of friends. The originator is a member of the organization, while the receiver can be a member. It is possible for the organization to include a single member, i.e., the originator itself.

An originator may desire to use a public content site to share a representation of the original content. A public content site is a site that generates documents (e.g., web pages) that have shared content (e.g., pictures) embedded in them.

The term “public” is used herein to describe any part of a system that cannot be trusted to implement the organization's security policy. Other security policies may apply, and, therefore, something that is public within the meaning of this disclosure may, nevertheless, have limited access.

Examples of public content sites are social sites that produce documents containing shared content such as pictures, video and text. Examples are: Facebook, Twitter, LinkedIn and Google+. These sites allow receiving users to view documents with shared content and then share comments on the content. Social sites, like Facebook and Twitter, are commonly used to share text updates that are yet another form of content. Sites like YouTube specialize in sharing videos and text comments about them.

A site generates documents that are a collection of one or more elements. Each element contains a content or a reference to a content located in a particular content repository together with instructions on how to represent the content and other elements. For example, an HTML page is a document that can contain elements with text and references to photos.

Displaying of the document, when viewed by the receiver, allows the receiver to experience the elements' content embedded in the document. The experience is determined by applying the instructions in the document to the contents. An element's content is embedded in a document when a receiver experiences the part to be an integral part of the document and not a separate entity.

Each element's content can be carried inside the document, for example a TEXT content of an element inside an HTML document. An element can also have reference to a content located outside the document, and, when displayed, the reference is used to retrieve the content in order to display the document. For example, the reference can be a link to a content located in a content repository. Specifically, a user can embed a photo in an HTML page by placing an <img> element with its src attribute specifying a reference (URL) to the location of the photo content. Further, the receiver may view a web page, in which a photo uploaded by the originator appears scaled down and among many other photos and text.

Elements can be computed by code that is carried by other elements in the document. The product of executing such a code is, at the end, a modification of the elements, their contents and instructions from which the document is made.

When no confusion is possible, this disclosure will use the term “content” to describe both the content that is carried in a document element and the content that is referred to by a document element.

Further, when the document is an HTML page displayed in a web browser, the present disclosure will treat the URL that appears at the address bar while viewing the displayed document as another content part from which the document is made and an integral part of experiencing the display of the document.

Some sites group elements together according to their content. For example, a group may contain a reference to a photo and comments about it.

Public content sites are a specific subset of public sites. This subset allows for the shared content to be included in the documents they produce. Shared content is a content contained in a public content repository. The public content repository can be a sub-module of the public content site, a separate site controlled under the same policy as the public content site or a separate public site with its own separate policy. Users can originate shared content by uploading it to the shared content repository. Optionally, a public content repository can allow users to create, edit or transform shared content located in the public content repository.

When a user uploads an original content to a public content repository, it is stored as a shared content. The shared content may be identical to the original content, or it can be derived from it. The process of deriving the shared content can be performed by the originator, the client application used to upload the original content or by a transformation performed by the public content repository.

Examples of public content repositories are: Flickr, YouTube, Picasa, TwitPic and yfrog. These repositories also act as public content sites. Flickr, YouTube and Picasa are used in equal amounts as both but TwitPic and yfrog are mainly used as a repository for Twitter. Facebook has its own repository and, in addition, uses content coming from a proxy. The proxy is controlled by Facebook and receives a reference to pictures located in another repository. This proxy is also considered to be a public content repository because only content emanating from it can be viewed by the receiver, and the proxy is public and can perform any of the modifications or storage performed by other type of public content repositories. A public proxy for content is considered to be a public content repository that performs the upload operation for the user (pull the content.)

When no confusion is possible, the present disclosure will use the term “public content site” to describe both the public content site and the public content repository.

A limitation imposed by public content sites is that a document generated by them can only contain content that arrived from a predetermined list of public content repositories. The only way a user can share a content in a way that it will appear embedded, when displayed to a receiver, in a document generated by the public content site, is to upload the content to one of the public content repositories from the predetermined list. This upload operation can be automatically performed for the user, but it does not change the fact that the final content displayed in the document arrived from a public content repository.

Public content site allows a user to upload a content that contains a link to another content located in repositories outside the allowed list, but in this case the link itself will appear as the content to the viewer and not the original content located in the outside repository. A receiver will have to follow the link, for example by clicking on it, and exit the document generated by the public content site in order to view the shared content. The content in the outside repository will not appear embedded in the document that came from the public content site.

Content sites may allow a few options to control how documents with shared content will be displayed to a receiver. These controls do not allow the display process to include reference to a content in a repository that is not approved by the site. Public content sites also do not allow the shared content to take control on how the document is displayed and by this to circumnavigate around the limitations set on the controls. For example, shared content cannot add HTML elements to the document. Public content sites usually apply strict filters that comb the shared content to verify that it does not contain such controlled content. Public content sites can modify shared content in order to ensure that code in the shared content will not directly affect the display of the document. For example, text that contain code may be modified so it will appear as quoted text in the displayed document instead of affecting the way in which the document is displayed.

This invention is focused only on using such public content sites and does not attempt to improve the situation involving sites that are less specific than public content sites, such as web hosting sites, that allow any type of content, instructions or code to be uploaded.

As described above, an originator may desire to use a public content site to communicate original content by uploading it to the public content site. The public content site is not directly controlled by the organization. Most of these sites and repositories allow the originating user to have some control over the security policy such as access-control, for example, by controlling who can experience the shared content and generate secondary content in response (e.g., post text comments.) Most sites allow some form of deleting of the uploaded content so it cannot be viewed anymore by anyone.

However, the organization's security policy may have additional requirements for using a public content site. For example, a security policy may be required to be managed centrally by the organization and not by each originator, a content may be required not to be stored in a public content repository and all content uploads and viewing may be required to be audited and stored in a secure audit repository.

A problem that needs to be solved is how to allow the originator to use a public content site and, at the same time, to enforce the organization's security policy.

One solution, known in the art, is for an organization to trust its members to implement the organization security policy using the tools available in the public content repository and site. In addition to the known common problems of trusting a human operator to implement a security policy, there is also a problem in the degree of access-control given by the public content site tools. There is a clear tension between the public content site operator, on one hand, and the site users and the security policy that they are required to impellent, on the other. The security policy may require full control on who experiences their content, and, in many cases, it requires to limit access as much as possible, for example, to only other members of the same organization. In contrast, a public content site operator wants to promote the public content site as much as possible. One of the ways to promote the public content site is to allow access rights to the widest audience possible. Public content site operators also believe and act as if analyzing content generated by users for the site's own usage, such as targeted ads, is allowed. The organization security policy, on the other hand, may not allow it. In this case, the public content site will not supply the necessary tools to impellent the required policy. In short, the public content site operator has full access to all content loaded to it, regardless of the perceived control users or organizations believe they have. This includes a function of deleting a content that a public content site may supply. In reality, the content often continues to be stored on the public content repository or is copied to another repository, and only the public access to it is removed. Erased content may later reappear as a result of a legal action taken against the public content site in its native or hosting country, or a change in the public content site policy, a security breach or because of a technical failure. In addition, it is possible that the public content site will continue to analyze, for its own purposes, content that was presumably erased. Another known solution is for the organization to delegate the task of enforcing the security policy to the public content site. In this solution, the public content site is merged into the organization and becomes less public as a result. This invention does not deal with this solution that is cumbersome to the organization and the public content site.

Another known solutions is based on encrypting the original content to form a shared content which is then published on a public content site. The receiver, in this case, needs to run a manual process of extracting the shared content out of the document given by the public content site and then to manually run a decryption algorithm to turn the shared content back to its original content form. In other words, the content does not appear embedded in the document. In one instance of such method, called subliminal channel, the encrypted shared content is made to look like another content that is likely to be published in the public content site. However, the other content in itself, and without using the appropriate decryption algorithm, does not reveal the original content. In addition to being cumbersome, it requires the organization to trust the originator to perform the necessary steps. Using this method also requires a mechanism to manage the encryption keys, may have legal implications and does not solve auditing requirements that the security policy may have. Additionally, a public content site may block this type of content.

In another known solution, the originating user publishes content that is of type of a link or a key that can be used by the receiver to retrieve the original content. The original content is delivered by other means in which the organization can enforce its policy. In other words, the problem is avoided by not allowing the original content itself to be uploaded and by, instead, publishing a different content (such as link or key) that is allowed and can be used by a receiver to retrieve the original content. As explained above, this will not allow the receiver to experience the representation of the original content embedded inside the document. This invention does not deal with this solution which is cumbersome to the receiver.

Some public content sites allow a link to be embedded in the document being displayed in a way that the content referred to by the link will appear embedded in the document. However, as explained, public content sites allow such embedding to take place only to a predetermined list of public content repositories that does not include the secure content repository. This may be a result of the public content site's own security policy, which may be in conflict with the organization security policy, since, from the public content site perspective, mixing content from an unknown site may cause a security risk, such as cross site scripting (XSS), to the receiver (the secure content site is considered to not be a part of the predetermined list of the public content site.)

The security policy may specify what transformation must be applied to an original content and what transformations are allowed, before the content can be viewed by a receiver. For example, the security policy may specify that a copyright watermark must be added to all shared photos. As described, many public content sites perform some transformation on the original content before storing it as shared content. Such transformation may not be in line with the security policy. Examples of such transformations include changing a resolution of a photo or adding the public content site's watermark. In such sites, the receiver is denied access to the original content even if the originator had no intention to limit such access. For example, a medical doctor may upload an X-ray of a patient to a public content site. In this case, in addition to being in violation of a hospital's security policy, the uploaded picture may not be effective for other medical doctors because of the fact that the public web site transforms the picture into a low resolution image.

Another problem is a possible legal conflict. An organization may specify that all content generated by its members is fully owned by the organization, and the public content site may specify that any content uploaded to it is partially or fully owned by the site.

Security policy may also include auditing requirements. Public content sites supply audit information on when content was uploaded, but, usually, they do not supply information over who experienced the content, when, for how long and how many times. In addition, there is no mechanism available for an organization to aggregate the audit information from all sites and on all content uploaded by all its members, and there is no mechanism to store audit information in a secure audit repository.

The originator may decide to upload the same content (or variations of the same content) to multiple locations within a public content site or to multiple public content sites or a receiver can download the content and then upload it to a different location on the public content site or to a different public content site. In addition, different policy may be applied to content stored in the public content repository and to document produced by the public content site. This complicates the task of running a consistent security policy over all replications of the same original content.

### BRIEF SUMMARY

In its general aspect, the present invention is a method and system for solving the situation in which the originator wants to securely share an original content using a public content site and the receiver can view a representation of the original content embedded inside the document generated by the public content site. In addition, the organization, which is attempting to enforce a security policy and of which the originator is a member, is not required to have special arrangements with the public content site.

The invention solves the described problem by performing a method including a number of steps applied when an originator uploads content to a public content site and a number of steps performed when a receiver views the shared content at the public content site.

A system implementing the invention executes the steps of the method outside the public content site itself in a location considered to be secure, such as a client used by the users (originator or receiver) or on a secure node¹, such as a secure site or proxy. When executed on a client, the method can be executed in a sub-module added to the client (e.g., a web browser extension), in a sub-module used by an application running on the client (e.g., a library or an SDK) or in a specialized application (e.g., a smart-phone App.). When executed on a secure node, the originator or receiver can directly access the node as a secure site, or the node can be configured as a proxy in which traffic between the client and the public content site is directed to pass through the proxy. This can be arranged in a way that is transparent to the user, for example, by making the URL of the document appear unaltered. In addition, the originator can perform the upload part of the method manually and directly interact with the public content site. ¹As used in the present disclosure, a node is any part of the system that is performing a computation process and can communicate with other nodes, i.e., a node can be a client, server, browser, proxy, extension to a browser, extension to a proxy, or extension to a server.

In an embodiment of the invention, the steps performed during the upload phase replace the original content with a shared content. The shared content is fully compliant with the security policy such that the security policy allows it to be publicly published. The shared content is also such that it contains a signature which can be used to produce a representation of the original content.

In an embodiment of the invention, the steps performed during the viewing phase, extract the shared content out of the document received from the public content site. A signature is then extracted from the shared content and used to produce a representation of the original content in a way that is compliant with the security policy. The representation of the original content is embedded in the document received from the public content site and the resulting document is displayed to the receiver. The embedding can be done by adding to the document the representation of the original content, a reference to such original content or instructions, which, upon execution, perform the embedding.

The document may include a code (e.g., JavaScript) carried in it or referred to a code located in a separate document. Depending on the code, the content parts of the document might change. Depending on the implementation of the method, each such change may require a repeated execution of the part of the method performed when a receiver views the document. This is easy to implement if the method is performed on the receiver's client, but it is more involved if the method is performed on a secure node, such as a secure site or a proxy. When the method is performed on a secure node, one option is to execute the code on the secure node instead of, or in addition to, executing on the client (e.g. using Node.js.) An alternative is for the method to use the signature and perform the embedding by modifying the code itself in way that when executed on the client, the modified code will produce the representation to the original content embedded in the document.

In an embodiment of the invention, the receiver perceives the document produced by the method as if it was another document that would have been generated by the public content site if the originator had directly uploaded the original content and the receiver directly viewed it. The receiver viewing the displayed document can use several queues, usually visual, to confirm that the document came from the public content site. The client, used by the receiver to display the document, usually supplies such queues. In a web browser client, an important queue is the URL name that appears at the address bar while viewing the displayed document, the receiver can at any time verify the URL and validate the site. Some security attacks attempt to supply an alternative document without modifying the URL but these attacks are much harder to perform if the URL is encrypted (uses https scheme.) Other solution is for the public content site to supply additional content that is used as a visual queue to the receiver. For example, an icon or a page design can be provided that can be used to identify the site. Another example is a predetermined content which was agreed in advance by the viewer and was kept secret.

In an embodiment of the invention, the method, during the upload phase, stores the original content in a secure content repository and uploads the shared content that includes a signature. The method, during the viewing phase, extracts the signature from the share content and uses it to retrieve the representation of the original content from the secure content repository. Optionally, the security policy specifies that the secure content repository retrieves different representations of the same original content to different receivers.

In one embodiment of the invention, the signature is a computer code executed to embed a representation of the original content in the document.

In one embodiment of the invention, the representation of the original content is decrypted from the signature.

In one embodiment of the invention, a key is derived from the signature and used to decrypt an encrypted version of the representation of the original content.

In one embodiment of the invention, the method, performed when viewing, sends an audit event to a secure auditing repository indicating that a representation of the original content was viewed.

In one embodiment of the invention, the method, performed when uploading, sends an audit event to a secure auditing repository indicating that shared content was uploaded.

The shared content can have multiple parts located in the document received from the public content site.

In one embodiment of the invention, at least one part of the shared content is removed from the document before displaying it to the receiver.

In one embodiment of the invention, a representation of the original content is embedded in the document by taking the place used by at least one part of the shared content.

In one embodiment of the invention, information on where to position the representation of the original content in the document is extracted from the shared content.

In one embodiment of the invention, the method detects a group of document parts that contains the shared content and then uses the grouping information to position the representation of the original content.

In a system embodying the invention, a firewall located between the originator and the public content site is used to enforce a rule that only shared content, that is allowed by the security policy, is uploaded.

In one embodiment of the invention, the receiver can generate a derived content based on experiencing the representation of the original content. The receiver then sends the derived content for storage in a secure content repository using the signature as a tag which can later be used to access the derived content in the secure content repository. For example, the receiver can enter a comment after viewing the original picture, tag it with the signature and send it for storage to a secure content site. As explained above, the signature is built in such a way that it uniquely identifies the original content and, therefore, it is possible to collect in the secure content repository all derived content (e.g. comments) that were made about the same original content by searching for all derived content with the same signature tag. This method of collecting derived content is secure and aggregates all derived content regardless of which shared content or public content site was used to communicate the original content to the receiver. Optionally, the signature can be used to retrieve derived content from a secure content repository and display it alongside the representation of the original content.

For example, an original picture, such as a photograph of a corporate meeting, is replaced with a shared content made from two parts: a generic picture of a flower and a URL to the original picture located in a secure content repository. The picture of the flower and the URL are uploaded together as a group to the public content site. In this example, the picture and the URL together form the shared content and the URL is the signature. The receiver retrieves a document from the public content site that contains the shared content. The method scans the document and searches for the signature, i.e., the URL to the secure content repository. When such URL is found, it retrieves the picture from the secure content repository using the URL and uses the retrieved picture to replace the picture of the flower. The result is a web page that, to the receiver, looks almost identical to the page received from the public content site. The only difference is that instead of the picture of the flower the receiver sees the picture of the corporate meeting.

In another example, the shared content described in the previous paragraph contains only one part: a generic picture which is modified to contain additional information that can then be used to extract a signature from the shared content. For example, a QR code of the signature may be superimposed on top of the generic picture.

In a further example, the original content is a text message, and the shared content is an encrypted version of the text message. The originator performs the upload action by publishing or posting the encrypted text on a public content site. The site stores the encrypted text in a data base and later retrieves it and inserts it into the document. The method scans the document for encrypted messages and, if found, it decrypts them and replaces the encrypted text with the decrypted text.

In another example, the original content is a picture that is transformed to produce a degraded version of the same picture that is acceptable by the security policy to be publicly published. In addition, a special watermark is added to the degraded picture to identify it as a shared content. The method scans the document for images containing the watermark and uses the shared picture to produce a signature. The method then uses the signature to retrieve the representation of the original picture and replaces the shared picture with the representation of the original content.

In a further example, the original content can be a deep-link to a secure site. Posting the deep-link on a public content site violates the security policy. Instead, the originator posts a generic link and a signature. The method then converts the generic link back to a deep link using the signature.

### BRIEF DESCRIPTION OF THE DRAWINGS

The invention is herein described, by way of example only, with reference to the accompanying drawings, wherein:

FIG. 1 illustrates schematically a simplified system according to conventional art in which content is shared using a public content site.

FIG. 2 shows a flowchart for a method to securely share original content using a public content site.

FIG. 3 illustrates schematically a simplified system to securely share original content using a public content site.

FIG. 4 shows a flowchart for a method to securely publish a picture on a public site using QR code.

FIG. 5 shows a flowchart for a method to retrieve original picture in a web page containing pictures with QR code.

FIG. 6 demonstrates an original picture and a secured picture protected with QR code.

FIG. 7 shows a flowchart for extending an original document based on an image located in the original document.

The foregoing and/or other aspects will become apparent from the following detailed description when considered in conjunction with the accompanying drawing figures.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

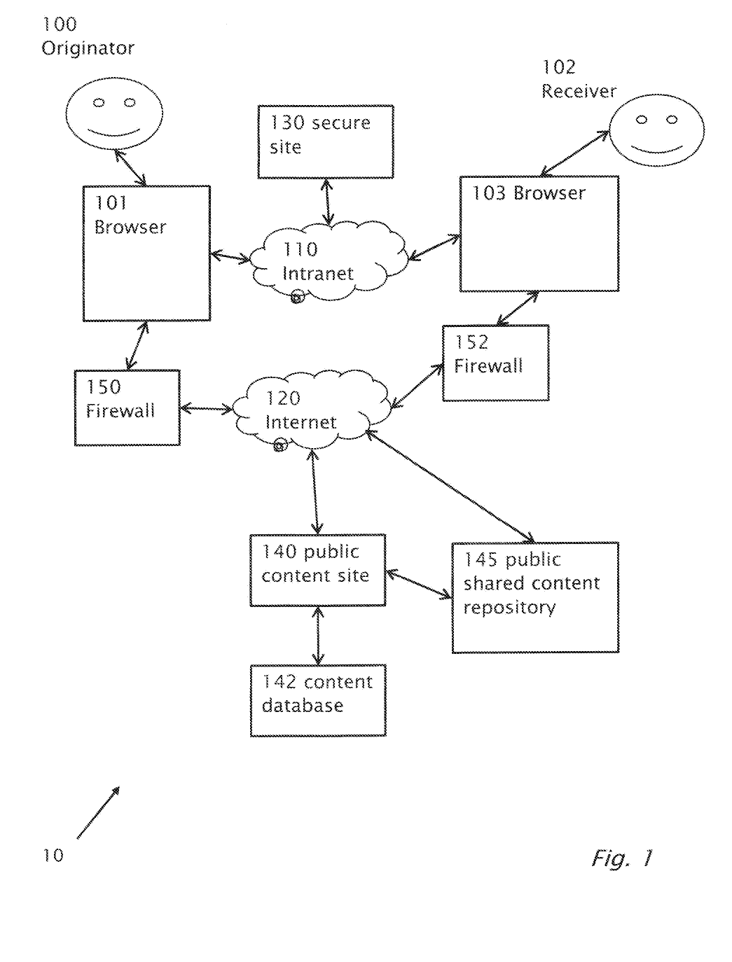

Reference is now made to FIG. 1 that illustrates schematically a simplified system 10 in which content can be shared on a site, according to conventional art. System 10 includes more than one user 100, 102 that belong to the same organization. Typically, the users use their browsers 101, 103 as the client. The browsers can communicate with a public content site 140 and public shared content repository 145 over the Internet 120. Users that are connected to a secure network 110 can also use a secure site 130 over the Intranet 110. The Intranet 110 may be extended to include remote users using a secured connection over the Internet such as VPN. The secure site 130 has the advantage that on it the security policy of the organization can be enforced, to help with the enforcement, the organization can apply a firewall 150, 152 that limits what can be uploaded to or viewed from a public content site 140.

An originating user 100 creates an original content, for example by taking a photo with his camera. The originating user then uses his browser 101 to upload the content to a public content site 140. The public content site can store the content in its internal content database 142 or in a public shared content repository 145. The originator can upload directly to a public shared content repository 145 and then upload a reference to the content to the public content site 140. The originator can give a reference to the shared content and the public content repository 145 will pull the content. All of these variations will be described herein as uploading shared content to the public content site 140. The originator connected to the Intranet 110 can also upload to the secure site 130.

The original content is thus transformed into a shared content on the shared content repository 145 and becomes accessible to other users either directly 145 or through a public content site 140, according to the public site's policy. The public content site 140 generates documents that include embedded content taken from the public shared content repository 145 but it does not generate documents that create embedded content taken from the secure site 130. Public content site 140 can use the Internet 120 or a private connection to communicate with a public shared content repository 145. In this system 10, the shared content acts as a representation of the original content and, therefore, the security policy should be applied to it regardless of where it was uploaded. The transformation of the original content into shared content can be as trivial as copying the content, changing its format or reducing the amount of information in it. The transformation can be performed by the originator 100 running, for example, an image manipulation tool, or by the browser 101 or by the sites 130, 140 or 145 or by any combination of these. The same site can have several different versions of the shared content all derived from the same original content. It is possible to have more than one site, public or private, each having a shared content derived from the same original content. Accordingly, the organization's security policy can be put at risk of not being implemented if the originator decides to upload the original content to a public content site 140. In order to avoid such a risk the organization may apply a security policy on its firewall 150 to block such an upload. Users using mobile devices can be configured to connect to the Internet through the firewall and in some cases direct access of such devices to the Internet can be physically blocked. However, an originator can privately own a client that is directly connected to the Internet, for example, a smart-phone connected over a mobile network or a computer located outside the organization, and can use this client to bypass the security policy. Organization may not be able to block uploads using the firewall because allowing some uploads is required for performing the organization's activity (e.g. marketing) or because there exists another organizational policy that allows it.

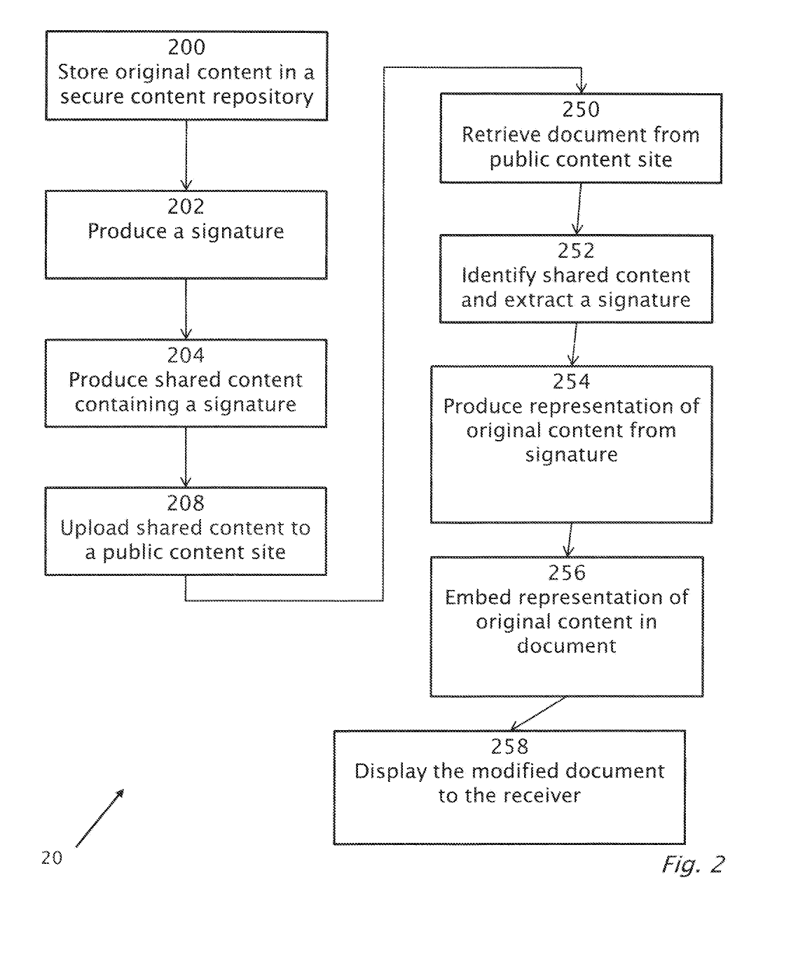

Reference is now made to FIG. 2, which illustrates schematically a method 20 in which an original content can be securely shared over a public content site. The method preferably includes two phases: steps 200, 204, 208 performed when the original content is uploaded; and steps 250, 252, 254, 256, 258 performed when the shared content is viewed. In step 200, the original content is stored in a secure repository. The secure repository can be located on the originator's client or on a different node. If the content repository is local, means to accessing it should be made, for example, using file-sharing technology between clients, such as peer-to-peer networks, e.g., Bit-Torrent, or commercial solutions such as Dropbox. If the content repository is located outside the client, it should be secured and, preferably, the connection used to perform the storage should also be secure. For example, the secure content repository may be located on the Intranet, and the connection between it and the client may run over the Intranet.

Optionally, a modification may be performed on the original content before storing it in the content repository, if such a modification is done, then any representation of the original content will be derived from this modification. For example, the original content may be encrypted before storing it in the secure content repository. In such an event, the secure content repository does not necessarily in itself needs to implement the security policy and instead the security policy is implemented by the key management used to decrypt the encrypted original content. Another example of modifying the original content is reducing its size before storing it in the secure content repository.

As an alternative to storing the original content in a secure content repository 200, the original content or a modification thereof can be encrypted, and the encrypted version then used in the next step 202 as the signature that is stored in the shared content. Using encryption to store content in the share content allows the usage of the shared content as a secure content repository.

Next, a signature is produced 202. The signature identifies a representation of the original content. In one embodiment, the signature is a reversible transformation of the original content, for example, an encryption of the original content. In another embodiment, the signature cannot by itself be used to produce a representation of the original content but it can be used to identify a representation of the original content in the secure content repository. For example, the signature can be a key, path or a link locating the representation in the repository. In this case, the signature is generated as part of storing the original content in the repository 200, the client storing the content can decide on a signature and send it to the repository with the content or the repository can decide on a signature and return it back to the client as part of the storage process or a signature is computed from the original content separately on the client and on the repository. When computing the signature from the original content. It is possible to first degrade the content and then compute the signature from the degraded content. An example of computing a signature from picture content is to compute the low frequency Fourier Transform coefficients of the picture and use the values of the coefficients as the signature.

In the next step 204 a shared content is produced. The share content can contain more than one part. Each part can have a different type of content (pictures, text, links or code). At least one part must contain a coding of the signature. The signature is coded in the type appropriate for the content type of the part. For example, the signature can be coded as part of a text, part of a link, part of a computer program, or part of a picture. When coded as part of a picture, one option is to use QR coding to produce an image that is then superimposed on a part of an entire picture that is part of the shared content.

Optionally, the part of the shared content containing the signature also contains an additional information that will later help to identify it. This can be done by a special mark added to the content, or by using the signature itself as a mark. For example, the signature can be coded as a string with a fixed structure. For example, the signature is coded as a URL and is identified as a signature when the URL meets predetermined values for scheme, host, port, and path prefix.

The shared content will be visible to anyone who will have access to the public content site or repository and therefore can contain additional content that may have significance to an anonymous user. The shared content may contain marketing information. The shared content may also contain a degraded version of the original content in a way that allows it to be published according to the security policy. For example, a face in an original picture can be masked out and the masked picture used as a shared content. In this case, the masked area can be used to store the coded signature. For example, the original picture can be filtered or scrambled. If a degraded version of the original content is in the shared content, it can be used as the coded signature by applying a suitable function as described above.

At this point, the shared content is uploaded to the public content repository 208. The simplest option is for the originator to directly upload the shared content to the public content site. Another option is for the originator to upload the original content to a secure site and then load a reference to the content to the public content site. Another option is for the originator to upload the original content to a secure site and then the secure site performs steps 200-208. Another option is to use a dedicated client application that will perform the steps for the originator, for example a smart-phone App. Another option is to have the steps performed by a sub-module, used by one of the existing client applications, for example, an extension to a web browser. Another option is for a proxy to intercept an upload transaction from the client to the public content site and perform the steps. The sub-module or the proxy can be configured to intercept an upload action of the originator to the public content site to block the direct upload and to perform steps 200-208 in a way that the originator will perceive as if he uploaded content directly to the public content site.

The receiver performs steps 250-258. In an optional implementation, these steps are performed only on documents arriving from predetermined locations of predetermined public content sites. A document is retrieved from the public content site 250. If the document contains computer code or a reference to computer code then, optionally, the computer code is executed. This may have the effect of changing the content parts in the document. Optionally, the computer code continues running and after every change in the content parts, the steps 252-258 are executed again. A part of a shared content that contains a signature is searched for and identified in the retrieved document 252. More than one signature can be found in the same document and the same process 252, 254, 256 is repeated for each signature. The search 252 looks for content parts of the document that contain the special mark described in step 204. In an alternative implementation the document is searched 252 for parts that include content of the type that can hold a signature, e.g. pictures. An attempt to decode a signature on each such part is performed, if successful, the signature itself is tested for an appropriate structure as described in 204. Optionally if the content part is referred to by the document then it has to be retrieved using the reference before an attempt to decode a signature can be made.

Next, the method produces a representation of the original content from the signature 254. In an embodiment, the step 254 uses the signature to generate a request that is sent to the secure content repository that sends back information that is then used to produce the representation of the original content. For example, if the signature was a URL directed at the secure content repository, then the method uses the URL to retrieve the representation of the original content from the repository. The signature can be a key and the method can build a URL by adding the key to a pre-configured URL of the repository. The signature can also be a file path used to access the representation from a file sharing system. In addition, the secure content repository can return that the signature is not recognized or that the representation was removed from the repository. Treatment of the signature is dropped if it is not recognized and special error-message content can be used, instead of the representation of the original content, if it was removed from the repository.

Optionally, the signature includes a decryption-key. The decryption-key is used to decrypt the representation before it can be used in the following steps. The encrypted representation can be retrieved from another part of the signature or by other means not using the document.

In a different embodiment the signature itself is converted to the representation of the original content (e.g., signature is an encrypted text) that is then decrypted by step 254 to form a representation of the original text, this embodiment requires an additional key management system. The key can be extracted from a signature, see above, or any key systems known in the art can be used, for example, fixed passwords, or Kerberos key management system.

Step 256 embeds the representation of the original content, or a reference to it, in the document received from the public server in step 250. In order to embed the content, step 256 needs to decide where in the document to embed the content and what parameters to use when embedding it. For example, in the case of a photo, step 256 needs to determine the location the photo will take in the building of the document and what dimensions the photo will have. In one embodiment, the step searches the document, retrieved from the public server, for a content of the same type as the representation of the original content and that is grouped together with the part of the shared content that was used 252 to produce the signature. The step then uses the parameters of the found content to position the representation of the original content. For example, the shared content contains a signature, which is a URL, that is grouped in the document with a generic photo. The step uses the photo retrieved with the URL in step 254 and places it in the location and dimension used by the generic photo. In another example, the signature is extracted from a shared photo 252 and the retrieved photo 254 is placed in the location of the shared photo. In another example, the representation of the original content is decrypted from a shared content and is placed in the location in the document taken by the shared content. Optionally, the embedding is performed by editing the computer code carried or referred to by the document in such a way that executing the new computer code will result in the representation of the original content or a reference to it.

Optionally, the embedded content can include a derived content, such as comments, pulled from the secure repository that has the signature as a tag.

Optionally, the embedding can add a user interface that allow the receiver to enter derived content, such as comments, and store it a secure repository using the signature as a tag.

In step 258 the modified document that includes the representation of the original content is displayed to the receiver. This step can use the same mechanism that would have been used to present the document retrieved from the public content site without the method described. For example, using the web page display capability of a browser. If step 256 used a modification of computer code, to embed the representation of the original content, then executing this computer code performs the display of step 258. In an alternative, steps 250-256 are performed in a proxy server and the display step 258 involves sending the modified document to a client that generates the display of the document to the receiver.

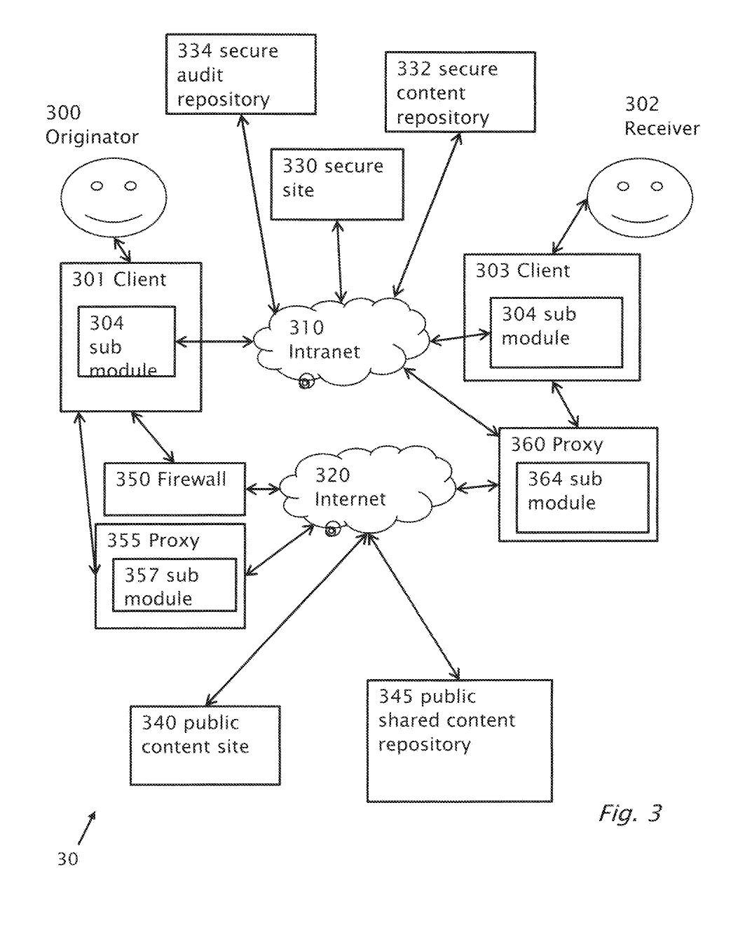

Reference is now made to FIG. 3 that illustrates schematically a system 30 in which an originator 300 wants to share a content with a receiver 302 using a public content site 340 but without risking the organization's security policy. The original content is converted to a shared content and published on the public content site 340. The published shared content does not risk the security policy. The original content is uploaded to a secure content repository 332 on which the security policy is enforced. As an optional step, an audit of the upload is recorded in a secure audit repository 334.

In an embodiment of the system, the originator uses the client 301 to upload the original content to a secure site 330. The secure site stores the content in a secure content repository 332. The client 301 generates a shared content and uploads it to the public content site 340. In an alternative implementation, the secure site 330 generates the shared content and sends it to the client for upload. In a further alternative implementation, the secure site 330 uploads the shared content to the public content site 340 on behalf of the originator, using an API protocol supported by the public content site, for example, REST protocol based on OAuth2.

Optionally, the shared content can contain a reference to an additional shared content located in a public site. Optionally, the additional shared content was not uploaded by the originator's client or by the secure site.

In one embodiment of the system, a sub module 304 of the browser/client 301 performs the above referenced steps in a way that the originator will perceive it as if the original content is directly uploaded to the public content site.

In one embodiment of the system, a sub module 357 of a proxy 355 performs these steps in a way that the originator will perceive it as if the original content is directly uploaded to the public content site.

The organization can optionally enforce its security policy using a firewall 350 in a way that ensures that only a shared content that is allowed by the security policy is uploaded to the pubic site 340. The enforcement can be implemented by allowing only content with signature to be uploaded. The detection of the existence of the signature is done as described in 252.

The receiver 302 uses a client 303 to retrieve a document from the public content site 340 that contains the shared content. In one embodiment of the invention, a sub module 304 of the client 303 monitors the content of the document retrieved and modified it accordance with method 20. In another embodiment of the invention, the receiver's 302 client 303 is connected to the Internet and the public content site 340 through a proxy 360 on which the security policy is enforced. The proxy 360 retrieves the document from the public content site and then forwards it to the receiver's client. The proxy 360 has a sub-module 364 that monitors the content of the document retrieved and modifies it according to method 20. The proxy then forwards the modified document to the receiver's client.

In another embodiment of the invention, the receiver 302 uses its client 303 to connect to a secure site 330. The secure site pulls the public content site for the document, modifies it and presents to the user the modified document.

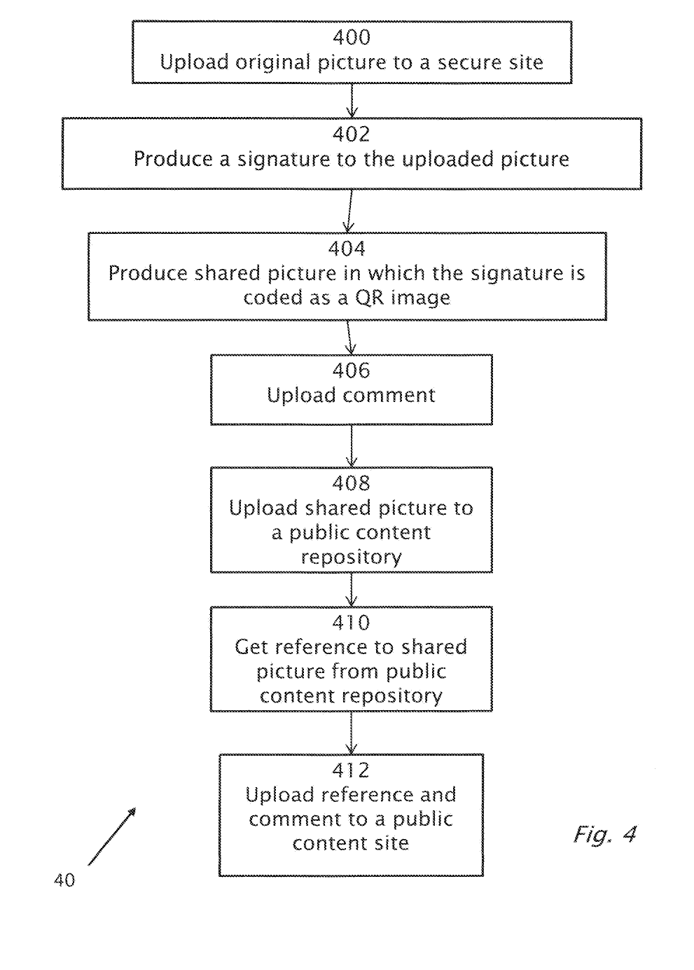

Reference is now made to FIG. 4 that illustrates schematically a preferred method 40, in which an original content can be securely uploaded to a public content site. An originator is using his browser to access a secure web site. The originator uses the browser to upload an original picture to the secure web site 400, the secure site stores the picture in its internal secure picture repository, the store operations generates a signature that can later be used to uniquely identify the picture in the repository 402.

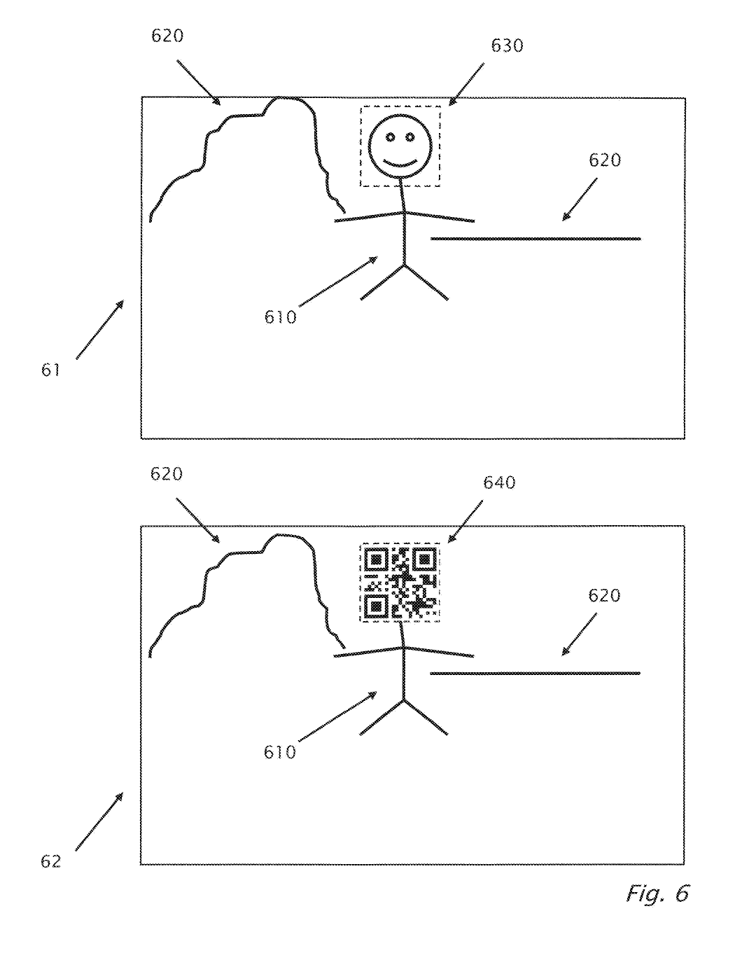

Next, the secure site produces a web page with multiple options of the picture transformed to be a shared picture that is safe for upload 404. One option is a picture that only contains a QR image coding the signature. The secure site does not have to generate the QR image, and instead it uses the signature to build a link to a public web site that generates QR images. The link is embedded as an <img> element in the web page produced by the secure site. The secure site itself produces a second option for a shared picture. It takes the original picture from the repository and superimposes on it the QR image from the public QR generator; an example is given in FIG. 6 below. The secure site itself produces a third option for a shared picture. It takes a neutral picture that has no security implications for the user and superimposes on it the QR image from the public QR generator.

The originator selects one of the shared picture options from the web page displayed and optionally adds comment to describe it or the original picture 406.

The originator selects on which public content site the picture and comment should be published. Some public content sites (Facebook) supply an API that accept the comment and the link to the picture (which is on the secure site or on the public QR generator) and uploads it to the public content site 412 (skipping steps 408, 410), while other pubic content sites (Twitter) requires the picture to be uploaded to a public picture repository 408 (e.g., TwitPic, yfrog, flickr) and to receive back a link to the picture located in the public content repository 410. Only then the link and the comment can be uploaded to the public content site 412. Some APIs can be executed as JavaScript running inside the originators browser, while other APIs can be utilized using a secure protocol between the secure site and the public content repository and public content sites. These protocols, commonly implementing OAuth2 protocol, allow the secure site to represent the originator. Once in a while, the originator is required to authorize the secure site to represent it in front of the public site.

Some APIs (e.g., Facebook) allow for insertion of an additional URL to a site. This additional URL can be used to point back to the image stored in the secure site. An authorized viewer that does not have an automated solution to replace the substituted image with the original image can nevertheless use the additional URL to manually retrieve the representation of the original picture.

In an alternative embodiment to FIG. 4, the steps 400-402 are performed in a different server from steps 404-412. The signature generated in step 402 is a URL to the original picture stored in the first server. The user passes this signature URL to the second server. The second server embeds the signature URL inside the shared picture; this will allow an authorized viewer to extract the signature URL from the shared picture and to use it to directly retrieve the original picture from the first server. As an alternative, the second secure server can store the signature URL and create a second signature to be used in the shared picture. The viewer will then use the second signature to retrieve the signature URL from the second server, and then use the signature URL to retrieve the original picture from the first server. If, in step 404, the second server generates an option for the shared picture made from the original picture then a security policy should be established between the two servers that will allow the second server to retrieve the original picture.

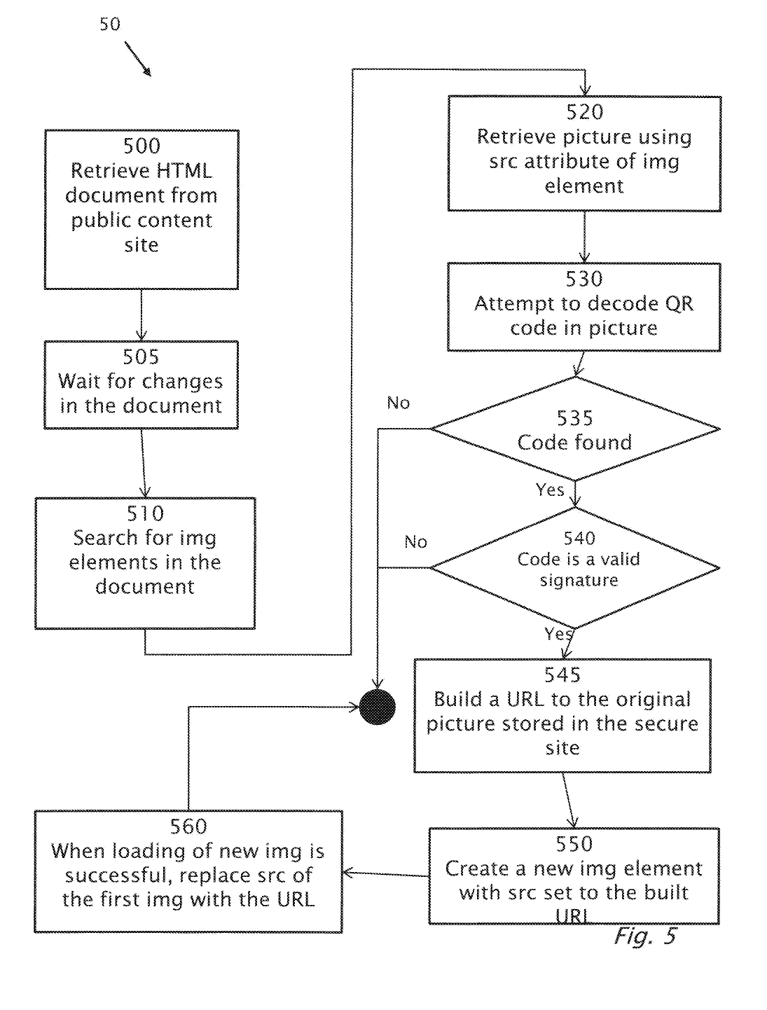

Reference is now made to FIG. 5, which illustrates schematically a detailed method 50 in which a receiver can view web pages containing original content that were uploaded using a method of the invention. The method is implemented as an extension to a browser (e.g., Google's Chrome.) The extension has a piece of (JavaScript) computer code that is executed every time a web page is retrieved from a site 500 in a tab or window of the browser. The method can optionally check from which URL the page came and to execute the rest of the steps only for pages that arrived from known public content sites (e.g., Facebook, Twitter.) Next, the code listens to events indicating that the document has changed and the rest of the steps are executed every time there is such a change 505. Such a mechanism is necessary because it is common for web sites to produce web pages that contain in them computer code that once in a while modify the document structure. These modifications happen in response to other events such user interactions, timers, or information that arrived from a remote server. Such events can create a cascade of document modifications events and it is therefore necessary to wait until such bursts of events ends and to apply the next step 510 only when the document stabilizes.

The modification of the document by the method starts by searching for all elements with the tag name <img> 510. For every <img> element that is found, the picture it is pointing to is retrieved 520. The link to the picture is kept in the “src” attribute of the element. Some browsers do not allow the computer code of the extension running inside the web page to retrieve the picture if it is located on a different scheme, host or port than the web page and in this case the retrieval process should be performed by a separate piece of computer code running in the background. The retrieval can take some time so the following steps can be performed (asynchronously) when the retrieval is completed successfully.

Once the picture's pixel content is retrieved, an attempt is made to decode QR code in it using an image processing method known in the art 530. If the decoding fails 535, the handling of the <img> element is aborted.

The QR code is tested to be a valid signature 540. For example, a signature can have a format that looks like “<number>-<number>”. For example, the signature should look like a valid URL with a scheme, host, port and prefix of the path set in advance to match the location in which the secure site stores the original pictures.

If the signature is valid, it is turned into a URL to the original pictures 545. If the signature itself is a URL then no action is needed, but if its just a key then a prefix may be needed to attach to it to form a valid URL.

Next 550 a new <img> element is created and its “src” attribute is set to the URL. This will cause the browser to retrieve the original picture from the URL. However, the new element is kept hidden so the user does not observe its intermediate state while the original picture is loading.

This retrieval can take some time and can fail, so the next step 560 is performed only on a successful retrieval of the original picture. Optionally, if the retrieval fails, the URL can be replaced with a preconfigured URL of a picture representing an error or a denied access.

In step 560 the URL is used to replace the “src” attribute of the first <img> element that was used in step 510, 520, for example the new <img> can keep a reference to the first <img>. This change will cause the browser to retrieve the original picture from the URL and display it to the user according to all the other attributes of the first <img> element. The image is now cached on the browser so the retrieval is immediate and successful. Optionally, code may adjust the size of the <img> so it will fit the width of the picture it shared picture being replaced while keeping the aspect ratio of the original picture.

Optionally, the computer code performed at the end of a successful retrieval of content from the secure site can add additional elements on top of the replaced picture. For example, a watermark or copyright notice. Optionally, the added elements can be active: a link to the secure site or a button that runs more code that allows the receiver to enter a comment on the picture and send it to the secure site and another button that allows the receiver to view other comments entered on the same picture regardless of where the picture was presented. For example, a comment could be entered on the picture as it appeared in a Twitter page and latter a receiver will be able to read the comment while viewing the picture appearing in a Facebook page.

Optionally, a repeating interval timer event can be attached to the <img> element. The event will repeatedly update the secure site with audit information. The audit information will indicate that a document containing the original picture is open in a browser. The audit update can include information on the URL of the public content site, who is viewing the original picture and from where. The timer events will stop once the <img> element is no more displayed to the user.

The process of iterating over <img> elements and their “src” attribute can be expanded to other elements and attributes that contain reference to pictures. For example, elements that have CSS background image property. However, an image that is too small or is defined in a way that it appears in more than one element (for example using class definition in a CSS file) is not likely to contain shared content and therefore can be skipped.

An alternative to FIG. 5, is for the user to use a bookmarklet. This solution requires the user to wait for the page load to stabilize, steps 500, 505. Once finished, the user can select from his browser a preconfigured bookmark containing Javascript code (bookmarklet) to automatically perform the following steps. However, the Java script code of a bookmarklet cannot retrieve the picture content (step 520) if it is coming from a different server. It is however possible for the bookmarklet to attempt to use the value of the <img> “src” attribute as the source of information from which the original picture will be eventually be retrieved from the secure server. This value is typically a URL (we will call it img-src-URL) to the shared picture stored on a public shared content repository.

The bookmarklet has two options to convert the img-src-URL into a URL to the original picture stored in the secure server.

In the first option, the bookmarklet can parse the img-src-URL and try to see if the img-src-URL itself (and not the picture content) contains a hidden signature (step 530.) This situation can happen if the public site that supplied the page and the img-src-URL is using an image proxy. The img-src-URL is pointing to an image proxy that is acting as a public shared content repository. When used, the image proxy parses the query parameters inside the img-src-URL which contains the URL to the shared picture; the image proxy then retrieves the shared picture and performs on it public transformations such as storage for latter analysis and then sends the picture to the user. As explained before (step 412) some public sites (Facebook) allow the shared picture to be located on the secure server and when posting with the sites API its possible to give a link to the shared picture, the public site then builds the img-src-URL with the URL to the shared picture as a query parameter. This allows the secure server to arrange a special URL to a shared picture that contains in it the signature of the original picture. When done, this allows the bookmarklet to parse the img-src-URL to extract the URL to the shared picture and then parse the shared picture URL and extract from it the signature of the original picture, this saves the need to perform image retrieval and processing by the Javascript on the browser.

The second option for a bookmarklet will work on any public site and is not limited to sites using image proxy (e.g. Twitter.) In the second option the bookmarklet uses every img-src-URL of every <img> as a signature. In other words it does not retrieve the image (520) and it performs a trivial decoding of using img-src-URL as the signature (530) and it assumes the decoding is always successful (535, 540.) In step 545 the bookmarklet build URL to the original picture stored in the secure site in the following way: this URL is pointing to the secure site and it contains the img-src-URL as a query parameter (the reverse of what we described for an image proxy.) The browser then retrieves the original picture from the secure site using the URL 550 (unlike Javascript, there is no limit on what value is used in the <img> “src: attribute.) The secure site extracts the img-src-URL from the query parameter and performs steps 520-540 that were skipped by the bookmarklet. If the secure server decides that the picture pointed to by img-src-URL is not a shared picture (520, 535 or 540 fail) then the secure server simply does not reply to the request this has the effect of not performing step 560 and therefore the picture as it was received from the public site remains in place. However if successful the secure server uses the valid signature to retrieve the data for the original picture and send it back to the browser as the reply to the URL that was built in step 545. The bookmarklet then processed to step 560 in which the same URL and image is used on the <img> element displayed to the user.

Optionally, the secure server can perform the same parsing of the img-src-URL that was performed by the bookmarklet in the first option.

Optionally, the secure server can cache the img-src-URL and the signature which was found in it (or was not found) and on latter events it can use the cache to give a reply without performing steps 520-540.

Optionally, when a user uses the secure site to post to a public site using an API supplied by the public site (step 408) it may be possible that the API returns the URL in which the shared picture is kept in the public content repository. With this URL in hand, the secure server can pre-populate the cache with a relation connecting the URL of the shared picture (which will latter arrive as the img-src-URL) with the signature to the original picture.

Reference is now made to FIG. 6, which illustrates schematically a possible shared picture content. This illustration is given as an example only and in no way is limiting the scope of this invention. Original picture content 61 is made from a person 610 positioned in front of a background 620. The sensitive area in the person, his head in this example, is identified 630; the identification can be performed manually or using an automated face detection method known in the art. Output shared picture content 62 is made from the same picture except for the sensitive area. The sensitive area in this example is masked by an image of a QR code 640. The image of the QR code can be decoded into a signature that can be used to generate a representation of the original picture, or used to generate the part of the picture that was masked out.

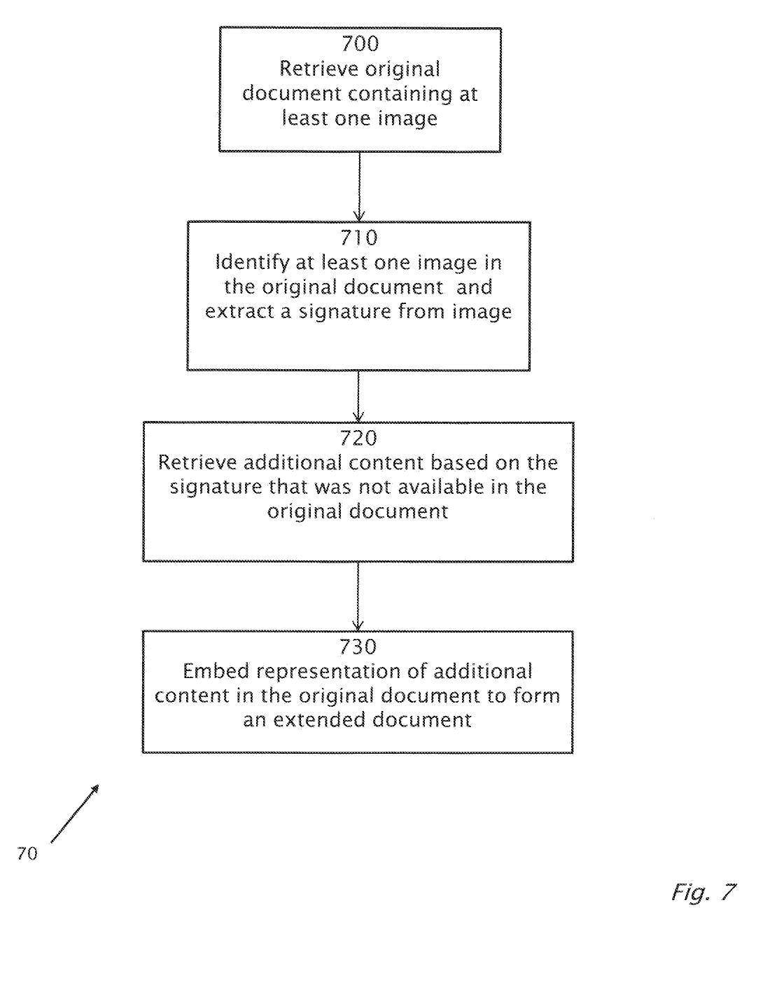

Reference is now made to FIG. 7, which illustrates schematically a method 70 that transforms an original document and generate a new document with extended content. An original document is retrieved 700. The original document must include at least one image. The method identifies the image and generates from it a signature 710. The signature can be a code that was placed in the image or it can be features extracted from the image, for example a checksum generated from the entire image or that identity of a person that was recognized in the image using facial detection method known in the art. Next the method retrieves additional information based on the signature 720. The additional information retrieved is an additional information that is not found in the original document. Preferably, the additional information is retrieved from a source that is different from the source from which the original document was retrieved. For example, the signature can be used to retrieve a different image that was not available to the source from which the original document was retrieved. For example, the signature is the identity of a person and the additional information is the name of that person. For example, the signature is a checksum of the image and the additional information are comments that were aggregated about the image that were collected from all sources and documents in which the image was placed. Finally, the additional information is embedded inside the original document to form a new extended document 730. For example the additional image can be embedded in the document by replacing the image from which the signature was made. For example, the person's name can be superimposed on top the image. For example, comments made on the image can be placed in the document next to the image.

It is to be understood that the present invention is not limited to pictures as content and any content that can be digitally described can be used. Examples are text, video and audio recordings. For example, the invention can be applied to text messages that are posted to a web site. In this example, the originator generates a text message that is replaced with a shared text that contains a signature. A sub-module of the receiver's browser identifies the shared text, extracts the signature and uses it to produce the original text and embeds the original text in the document presented to the receiver. In an alternative example, the original text is encrypted to form the shared text, and a sub-module of the receiver's browser decrypts the message.

The secure site can supply centralized audit information on all uploads and all attempts to view the original content based on the signature of the original content.

It is to be understood that the present invention is not limited to working over the Internet and it can be applied on local networks, Intranet or VPN in exactly the same way described.

It is to be understood that the present invention is not limited to working over an Intranet that is physically separated from the Internet and it can be applied to a system in which the Intranet is implemented over the Internet using VPN and/or using an appropriate security policy on secure nodes. For example, a smart phone using a mobile network can be configured to have its Internet connection redirect to the Intranet.

It is to be understood that the present invention is not limited to having all its subsystems and sub modules located in a single computer or one site and that the subsystems themselves can interact through a network such as the Internet.

It is to be understood that the present invention can be used to share any content between at least two people using a public content site. Including type of content, or specific content that are blocked by the public content site's policy. This is by using a shared content that is allowed by the public content site's policy but that can be used by the invention to present a document to the receiver with the content that is not allowed by the public content site.

It is to be understood that the words “displayed” and “presented” can be interchanged and used to describe the process in which the receiver can experience the content in some way regardless of the type of the content.

It is to be understood that method of the invention can be implemented as a sub-module or a computer library to which other application can attach.

Although selected embodiments of the present invention have been shown and described, it is to be understood that the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A method to produce a second document based on a first document retrieved from a server, the method including the steps of:
at the server
sending a first document including a first content to a node located remotely from the server;
at the node
extracting the first content from the first document;
using the first content to produce a second content; and
producing a second document including the second content.

2. The method of claim 1 wherein the first content is of a type selected from a picture type, a video type, a text type, a sound type and a computer code type.

3. The method of claim 2 wherein the second content is of the same type as the first content.

4. The method of claim 1 wherein the step of producing the second content further comprises
building a request using the first content;
sending the request to a secure content repository; and
receiving back from the secure content repository a data which is then used to produce the second content.

5. The method of claim 4, further comprising a step of storing the second content at a secure content repository.

6. The method of claim 5, further comprising a step of modifying the second content prior to storing it at the secure content repository.

7. The method of claim 1 wherein the second content is placed in a different location in the second document than a location of the first content in the first document.

8. The method of claim 1 wherein the step of using the first content to produce the second content comprises decrypting the second content from the first content.

9. The method of claim 1, further comprising a step of displaying the second document with the second content.

10. A method for allowing a content originator to modify displaying of a document to a document receiver, the method including the steps of:
including a signature in a content, the content being of a type selected from a picture type, a video type, a text type, a sound type and a computer code type;
producing a document including a reference to the content;
retrieving the document;
retrieving the content using the reference in the document;
extracting the signature from the content; and
using the signature to modify displaying of the document.

11. A method of conveying a secure content from an originator to a receiver, the method comprising the steps of:
producing a shared content derived from the original content, the original content having a type, and the shared content being of the same type as the original content;
using the produced shared content to generate a document including the produced shared content;
conveying the generated document to a receiver;
extracting the produced shared content from the generated document;
producing a representation of the original content using the extracted produced shared content;
replacing the shared content in the generated document with the produced representation of the original content; and
displaying the document with the representation of the original content to the recipient.

12. The method of claim 11, wherein the step of producing the representation of the original content using the extracted produced shared content further comprises
generating a request,
sending the request to the secure content repository, and
receiving back from the secure content repository an information which is used to produce the representation of the original content.

13. The method of claim 11, wherein the representation of the original content is decrypted from the produced shared content.

14. The method of claim 13, wherein the produced shared content comprises a decryption-key, and wherein the decryption-key is used to decrypt the representation of the original content.

15. A system for sharing a secure content between an originator and a receiver, comprising:
an originating node located at an originator's side and comprising an original content, the original content being of a type selected from a video type, a picture type, a text type, a sound type and a computer code type;
a secure node operable to receive the original content from the originating node and operable to convert the original content into a shared content;
a public node operable to generate a document including the produced shared content;
a receiving node located at a receiver's side, the receiving node being operable to receive the generated document, to extract the produced shared content from the generated document, to produce a representation of the original content using the extracted produced shared content, and to replace the shared content in the generated document with the produced representation of the original content; and
a display device operable to display the document with the representation of the original content to the recipient.

16. The system of claim 15, wherein the representation of the original content is decrypted from, the produced shared content.

17. The system of claim 16, wherein the produced shared content comprises a decryption-key, and wherein the decryption-key is used to decrypt the representation of the original content.

18. The system of claim 15, further comprising a secure repository node operable to receive a request from the receiving node, wherein as part of being operable to produce the representation of the original content, the receiving node is further operable to build a request using the extracted produced shared content, to send the request to the secure repository node, and to receive back from the secure repository node a data which is then used to produce the representation of the original content.
